(19) United States
(12) Patent Application Publication
(10) Pub. No.: US 2009/0284827 A1
(43) Pub. Date: Nov. 19, 2009

(54) OPTICAL ELEMENT

(75) Inventor: Emile J.K. Verstegen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/722,359

(22) PCT Filed: Dec. 23, 2005
(86) PCT No.: PCT/IB05/54393

§ 371 Date: Jun. 21, 2007

(30) Foreign Application Priority Data
Jan. 5, 2005 (GB) 0500147.4

(51) Int. Cl. G02F 1/29

(52) U.S. Cl. 359/315

(57) ABSTRACT

An optical element (120; 220; 320; 420) includes a fluid material (104; 204; 304; 404) which is held between a first surface (106; 206; 306; 406) and a second surface (108; 208; 308; 408) and has a refractive index which is variable in response to variation of an applied field. The first surface and said second surface have respective first and second cross-sectional profiles, which vary in height when measured parallel to the optical axis of the optical element, across the respective first and second surfaces.

### FIELD OF THE INVENTION

The present invention relates to an optical element, in particular an optical element comprising a fluid material of variable refractive index, particularly but not exclusively a liquid crystal material.

### BACKGROUND OF THE INVENTION

Optical focusing systems having variable focal length are widely used in optical systems. In order to avoid using a mechanical unit to modify the focal length, non-mechanical optical elements of variable focal length have been proposed, for example liquid crystal (LC) lenses.

U.S. Pat. No. 4,466,703 describes a variable focal length lens having a liquid crystal (LC) sandwiched between two electrodes, one of the electrodes consisting of a plurality of concentric annular electrodes. A power source imparts a different potential to each of the annular transparent electrodes and applies an electric field of inclined intensity distribution to the liquid crystal, thereby causing the crystal to create a refractive index distribution having a lens action. The focal length of said lens action is varied by varying the electric field to be applied. However, this structure leads to complexity in manufacturing the lens.

An alternative is to have a LC lens made of a concave layer of LC material and a corresponding convex substrate of solid polymer material disposed between two electrodes connected to a power source, as described in U.S. Pat. No. 6,469,683. The configuration can also be arranged such that the concave shape is formed out of a solid polymer material and that the corresponding convex shape is formed of a liquid crystal material. The focal length of the lens is modified by changing the refractive index of the liquid crystal layer by varying the strength of the electric field applied between the electrodes.

A problem occurring with the use of liquid crystal lenses having to operate over a large focal range is that the switching speed of the liquid crystal material from one focal length to another does not meet the requirements put on cameras for example. The switching speed of the liquid crystal material is correlated to the liquid crystal layer thickness. As a matter of fact, the switching speed increases quadratically with the layer thickness so that for a 5 μm liquid crystal lens the switching speed is typically 10 ms, whereas for a 50 μm liquid crystal lens the switching speed is typically 1 second.

U.S. Pat. No. 6,469,683 also describes the use of a Fresnel lens structure. This reduces the thickness of the liquid crystal layer and thus improve the response time for the liquid crystal material to adjust to a desired focal length. Such Fresnel lenses have small and deep trenches which can be very difficult, if not impossible, to manufacture even using diamond turning. Moreover, a Fresnel lens is only designed for a particular wavelength. As a consequence, it is undesirable to use such a lens in applications that use light with different wavelengths, such as natural light in a camera for instance.

### SUMMARY OF THE INVENTION

In accordance with one aspect of the present invention, there is provided an optical element having an optical axis, said element including a fluid material which has a refractive index which is variable in response to variation of an applied field, wherein said fluid material is held between a first surface and a second surface, said first surface and said second surface having respective first and second cross-sectional profiles, wherein said first cross-sectional profile varies in height, measured parallel to said optical axis, across said first surface;

characterised in that said second cross-sectional profile also varies in height, measured parallel to said optical axis, across said second surface.

By use of the invention, differences in layer thickness across the fluid material, when measured parallel to the optical axis of the optical element, can be reduced. This has the advantage of making the electric field across the fluid material more homogeneous, thus enabling a more homogeneous switching, resulting in a homogeneous refractive index over the entire surface of the element and an improved switching speed of the fluid material from one state to another.

The switching performance is determined by the distribution of the applied electric field across the fluid material layer. For a constant voltage applied at the electrodes, the homogeneity of the applied field across the fluid material layer is improved if the differences in layer thickness across the fluid material are reduced.

Further, by reducing the thickness of the liquid crystal layer by means other than a Fresnel lens, the optical element of the present invention can be used in applications that use light with different wavelengths. Further, the use of two moulded surfaces of varying height can be used to improve manufacturability, by avoiding difficulty in manufacturing the small and deep trenches of a Fresnel lens on a single surface of varying height.

The first and second surfaces preferably approximately match, although being different in shape. The profiles are preferably, on the one hand, a refractive profile gradually varying in height which is approximated by a profile having discrete steps in height.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 is an enlarged sectional view of one embodiment of an optical element according to the present invention.

FIG. 2 is an enlarged sectional view of a second embodiment of optical element according to the present invention.

FIG. 3 is an enlarged sectional view of a third embodiment of optical element according to the present invention.

FIG. 4 is an enlarged sectional view of a fourth embodiment of optical element according to the present invention.

### DETAILED DESCRIPTION OF THE INVENTION

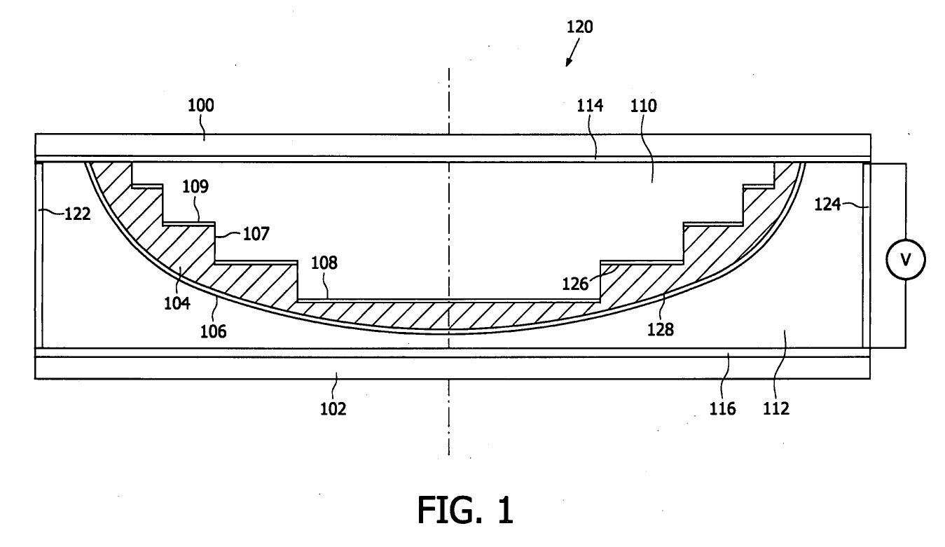

FIG. 1 is an enlarged sectional view of one embodiment of an optical element according to the present invention. In this embodiment, the optical element 120 comprises two transparent plates 100, 102 and two transparent electrodes 114, 116 each arranged to lie perpendicular to the optical axis represented in dotted lines. The electrodes are connected to a power source V and joined via insulator spacers 122, 124. Both electrodes can be formed out of indium tin oxide (ITO) coated glass, for example and are commonly applied on the inner side of the transparent plates 100, 102 by means of evaporation or sputtering. The optical element also comprises a fluid material 104 which has a refractive index which is variable in response to an applied voltage between the electrodes, the applied voltage being preferably an AC voltage. In this embodiment, the element is a liquid crystal (LC) lens and the fluid material is liquid crystal material. The thin material 104 is sandwiched between a first surface 106 having a first cross-sectional profile which is lens-shaped, i.e. generally spherical or aspherical, and a second surface 108 having a second cross-sectional profile different from the first one, which comprises a plurality of steps. The first and second profiles vary in height when measured parallel to the optical axis, across respectively the first and second surfaces. Each step of the second profile is formed by a first surface portion 107 substantially parallel to the optical axis and a second surface portion 109 substantially perpendicular to the optical axis. Preferably, the first and second surface portions 107, 109 of the second profile are respectively parallel and perpendicular to the optical axis with a maximum tolerance of ±20°. Even more preferably the maximum tolerance is ±10°. The plurality of steps have a substantially constant height and a decreasing width when measured parallel to the optical axis, across the second surface. In the case of a first surface profile being an aspherical lens profile having of two or more radii, the steps of the second surface profile would have a varying width in order for their height to be substantially constant.

The first and second surfaces are provided in the form of surfaces of one or more moulded substrates, more precisely two substrates designated 110 and 112 formed of transparent material, preferably of polymeric material. The process for obtaining the moulded substrates will be described later.

In this embodiment, alignment layers 126 are applied on the portions of the steps 109 of substrate 110 which are perpendicular to the optical axis and an alignment layer 128 is applied on the aspherical surface of substrate 106 as well. The alignment layers determine the liquid crystal molecule orientation that is induced in the material 104. The alignment layers may for example be formed out of polyimide. In case polyimide is used, a solution thereof might for example be spin coated and rubbed with a fabric after drying at an elevated temperature (e.g. 90° C.). The liquid crystal material 104 is confined between the substrates 110 and 112 and their associated alignment layers 126 and 128, thus forming a thin LC lens.

When a light beam passes through the optical element, refraction will occur at the spherical or aspherical surface of the LC lens whereas the plurality of steps will only have a limited influence on the LC lens function.

The advantage of this embodiment of the invention is that the difference in the liquid crystal thickness from the centre of the LC lens to the outside of the LC lens does not vary considerably as both profiles are substantially matching even if different in shape. Consequently, a better homogeneity of the electric field across the liquid crystal layer is obtained, thus leading to a better switching speed and better switching homogeneity which leads to improved optical quality of the optical element from one focal length to another. If for example the refracting surface is of an aspherical lens shape, the resulting optical shape should also be of similar shape, though, depending on the switching state of the variable refractive index medium, of different optical strength.

The polymer bodies of the substrates 110 and 112 might be respectively formed from a monomer dispensed in a mould using a photoreplication process involving the photopolymerization of the monomer. The mould shape from which the substrate shapes are obtained can be easily manufactured and is preferably obtained via diamond turning.

The step of polymerizing the monomer can be performed in many different ways. One particular approach is to use a photopolymerization process. The step of polymerizing said monomer involves exposing said monomer to electromagnetic radiation. The electromagnetic radiation is preferably ultraviolet light, and the monomer may comprise a photo initiator that accelerates the photopolymerization process.

Alternatively, or in combination, the step of polymerizing involves heating the monomer to a temperature above 30° C. and preferably above 120° C. for post curing of the monomer. The particular temperature required depends largely on the type of monomer at hand as well as on the type of initiator used.

In case exposure to electromagnetic radiation is combined with heat treatment, exposing the monomer to electromagnetic radiation may have a primary function of setting the shape of the lens, enabling the lens to be released from its mould. However, polymerization of the monomer using electromagnetic radiation only is not likely to reach 100% since gelation and/or vitrification of the monomer will reduce the mobility of the reactive groups. A post-curing step at elevated temperatures in or above the indicated ranges is therefore preferably employed in order to temporarily increase the mobility and thus push the polymerization towards 100%.

However, the monomer may be heated already while exposed for the electromagnetic radiation. The simultaneous effect of radiation initiated polymerization and heat induced mobility during polymerization has a synergy effect on the rate of polymerization and thus push the polymerization closer to 100%.

The substrates 110 and 112 are separately moulded then aligned during manufacture of the optical element.

FIG. 2 is an enlarged sectional view of a second embodiment of an optical element according to the present invention. This second embodiment is similar to the first embodiment in that the optical element 220 comprises plates 200 and 202, two transparent electrodes 214 and 216, and a liquid crystal material 204 sandwiched between first and second surfaces 206, 208 provided in the form of surfaces of two moulded substrates 210 and 212, thus forming a thin LC lens. The first surface 206 has a first cross-sectional profile which is spherical or aspherical and the second surface 208 has a second cross-sectional profile different from the first one but approximately matching, which comprises a plurality of steps. The first and second profiles vary in height when measured parallel to the optical axis, across respectively the first and second surfaces. However, in this second embodiment, the second surface portion 209 of the second surface 208 has a lens cross-sectional profile which is substantially perpendicular to the optical axis.

FIG. 3 is an enlarged sectional view of a third embodiment of an optical element according to the present invention. This third embodiment is similar to the first embodiment in that the optical element 320 comprises plates 300 and 302, two transparent electrodes 314 and 316, and a liquid crystal material 304 sandwiched between first and second surfaces 306, 308 provided in the form of surfaces of two moulded substrates 310 and 312, thus forming a thin LC lens. However, in this third embodiment, the profiles of the first and second surfaces have been inverted so that the first surface 306 has a cross-sectional profile which is a spherical or aspherical, and the second surface 308 has a cross-sectional profile which comprises a plurality of steps. Both profiles approximately match so that the difference in the liquid crystal thickness from the centre to the outside of the LC lens is not varying considerably.

An optical element arranged according to one of the embodiments illustrated in FIGS. 1 to 3 can be used for example, when associated with an image sensor, in a digital camera for achieving an adjustable depth of focus or focal plane. Furthermore a zoom function can be achieved. It may be used in combination with one or more fixed-focus lenses to provide a desired variability in the focusing function.

FIG. 4 is an enlarged sectional view of a fourth embodiment of an optical element according to the present invention. In this embodiment, the first surface 406 is a planar surface which is inclined relative to the optical axis whereas the second surface 408 has a cross-sectional profile which comprises a plurality of steps. A liquid crystal material 404 is sandwiched between first and second surfaces provided in the form of surfaces of two moulded substrates 410 and 412, thus forming a thin LC grating.

The above embodiments are to be understood as illustrative examples of the invention. Further embodiments of the invention are envisaged. For example, the invention could be used in any application in which some adaptive optical function is required. The optical element can be used in mobile phone cameras, in key ring cameras, in digital still cameras, video cameras, endoscopes, capsule endoscopes and arthroscopes. Alterative cross-sectional profiles may be envisaged, such as an aspherical profile matched by a profile having only one step. Other fluid materials of variable refractive index may also be used in accordance with the invention. For example, molecules comprising a charged substituent which can be rotated when subjected to a current created by a potential difference applied between two electrodes may be used. Further, when considering polarization sensitive LC lenses which are only controllable for light of a certain polarization, the superimposition of two optical elements having respective fluid materials of variable refractive index with perpendicular molecule orientation is envisaged. This will result in a polarization independent lens since all light traveling through the pair will be affected by one and only one of the two optical elements.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. An optical element (120; 220; 320; 420) having an optical axis, said element including a fluid material (104; 204; 304; 404) which has a refractive index which is variable in response to variation of an applied field, wherein said fluid material is held between a first surface (106; 206; 306; 406) and a second surface (108; 208; 308; 408), said first surface and said second surface having respective first and second cross-sectional profiles, wherein said first cross-sectional profile varies in height, measured parallel to said optical axis, across said first surface;
characterised in that said second cross-sectional profile also varies in height, measured parallel to said optical axis, across said second surface.

2. An optical element according to claim 1, wherein first and second profiles are different.

3. An optical element according to claim 1, wherein said second surface (108; 208; 308; 408) has a first surface portion (107; 207; 307; 407) substantially parallel to said optical axis and a second surface portion (109; 209; 309; 409) substantially perpendicular to said optical axis, said first and second surface portions forming a step in said second profile.

4. An optical element according to claim 3, wherein said second profile comprises a plurality of steps.

5. An optical element according to claim 4, wherein alignment layers (126; 226; 326; 426) are deposited on the second surface portions (109; 209; 309; 409) of said steps.

6. An optical element according to claim 4, wherein said plurality of steps have a substantially constant height.

7. An optical element according to claim 4, wherein said plurality of steps have a varying width across said second surface (108; 208; 308).

8. An optical element according to claim 7, wherein said plurality of steps have a decreasing width across said second surface (108; 208; 308).

9. An optical element according to claim 1, wherein said first surface (106; 206; 306) is a lens surface.

10. An optical element according to claim 1, wherein said first surface is planar surface (406) which is inclined relative to said optical axis.

11. An optical element according to claim 1, comprising two electrodes (114, 116; 214, 216; 314, 316; 414, 416) each arranged to lie perpendicular to said optical axis, wherein the refractive index of said fluid material (104; 204; 304; 404) is variable by applying a voltage (V) between said electrodes.

12. An optical element according to claim 1, wherein said fluid material (104; 204; 304; 404) is a liquid crystal material.

13. An optical element according to claim 1, wherein said first and second surfaces are provided in the form of surfaces of one or more moulded substrates (110, 112; 210, 212; 310, 312; 410, 412).
